(19) United States
(12) Patent Application Publication
(10) Pub. No.: US 2002/0034969 A1
(43) Pub. Date: Mar. 21, 2002

(54) Portable electronic devices

(76) Inventor: Henrik Sundstrom, Staffanstorp (SE)

Correspondence Address: Stanley R. Moore, Esq., JENKENS & GILCHRIST, P.C., 1445 Ross Avenue, Suite 3200, Dallas, TX, 75202-2799, US

(21) Appl. No.: 09/848,793

(22) Filed: May 4, 2001

(30) Foreign Application Priority Data
May 8, 2000 (GB) 0011105.4

(51) Int. Cl. H04M 1/00

(52) U.S. Cl. 455/566; 345/168

(57) ABSTRACT

A method for accelerated access to information represented by information indicators on a graphical display includes assigning labels (15) to displayed information indicators (13) and comparing the input from a user with the labels (15). Information relating to the indicator to which the label matching the input is assigned is displayed. Such a method accelerates access to the information.

The present invention relates to portable electronic devices, and in particular, but not exclusively, to mobile telephones and other mobile telecommunications devices.

### BACKGROUND OF THE INVENTION

Many portable electronic devices incorporate display devices which are used to display a variety of pieces of information in response to inputs received from the user of the device. One such piece of information that is becoming increasingly useful, is that of a calendar which is displayed in a graphical manner.

For example, such a graphical calendar display is shown schematically in FIG. 1 of the accompanying drawings. The display 1, in this example, includes an upper row 2 representing days of the week, and a lefthand column 3 indicating times of the day. On most portable electronic devices, the displaying device is not large enough to display the whole of a calendar in one image, and so it is usual to be able to navigate around the calendar using cursor or arrow keys, for example, in order to reveal different parts of the calendar.

In addition, the amount of display area restricts significantly the amount of information that can be displayed with regard to specific events or appointments defined by the user. In the view of FIG. 1, the white areas 4 are those time slots which are unassigned. The user can define a number of events or appointments for inclusion on the calendar, and these are represented by the crosshatched regions 5. For example in the calendar shown in FIG. 1, there is an event defined spanning the time 9.00 am to 11.00 am on Monday, another event spanning 11.00 am to 1.00 pm on Wednesday, and so on. In order to obtain full details of the event, it is necessary to select the relevant indicator. In the FIG. 1 example, the Wednesday appointment has been selected by the user, and it is usual that an additional key press will enable the information for that event to be displayed on the display device.

The arrow keys or cursor keys can also be used to navigate around the calendar in order to select different events. For example, the user might use the righthand arrow key to move from Wednesday to Thursday and then the down arrow key to select the appointment on Thursday at 1.00 pm. Information regarding that newly selected appointment can then be retrieved. Alternatively, a key press can step through the events in turn.

However, it is increasingly the case that new mobile electronic devices, and in particular mobile telephones, are becoming smaller and easier to use. It is therefore undesirable to require a user to make multiple key presses in order to access information relating to events indicated on a calendar display.

### SUMMARY OF THE PRESENT INVENTION

One embodiment of the present invention therefore provides a method of accessing information relating to events indicated on a calendar display, in which the event indicators are associated with labels. Access to the information indicated by the event indicator shown on the calendar display can then be accessed simply by the user inputting a symbol corresponding to the label concerned. The input can be via a voice signal or via a keypad input.

It is emphasised that use of the word “comprises” or “comprising” in this specification is taken to specify the presence of features, integers, steps or components, but does not preclude the presence of one or more additional features, integers, steps, components or groups thereof.

### BRIEF DESCRIPTION OF THE DRAWINGS

FIG. 1 is a schematic representation of a known graphical calendar display;

FIG. 2 is a schematic representation of a graphical calendar display in accordance with the present invention;

FIG. 3 illustrates a mobile telephone having a graphical display;

FIG. 4 is a block diagram of an electronic telecommunications device for use in accordance with the invention; and

FIG. 5 is a flow chart illustrating steps in a method in accordance with the invention.

### DETAILED DESCRIPTION OF THE PREFERRED EMBODIMENT

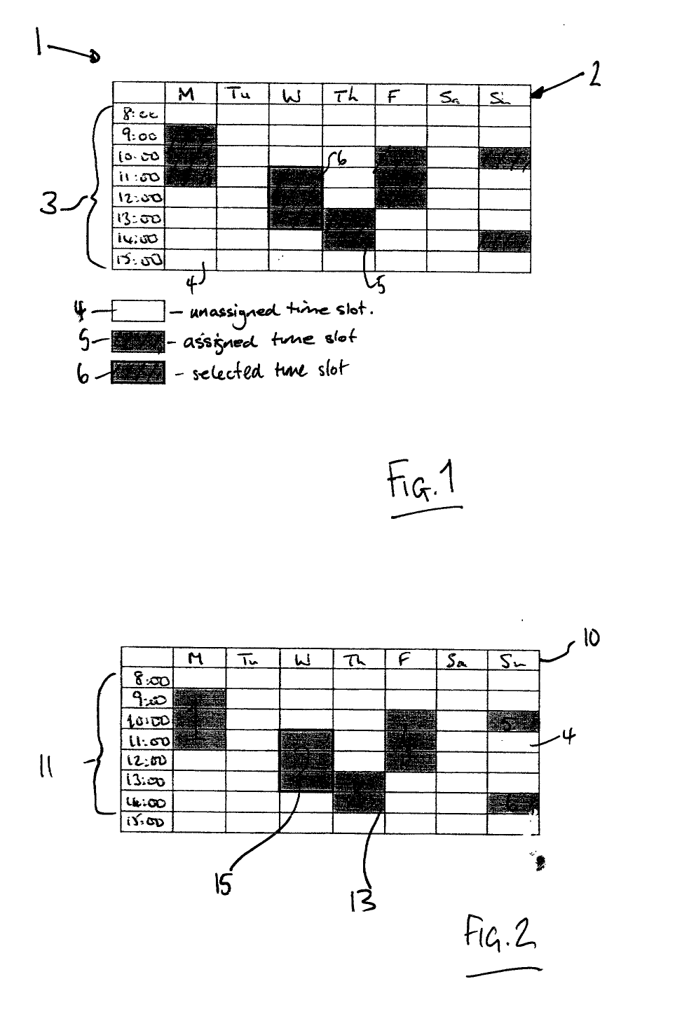

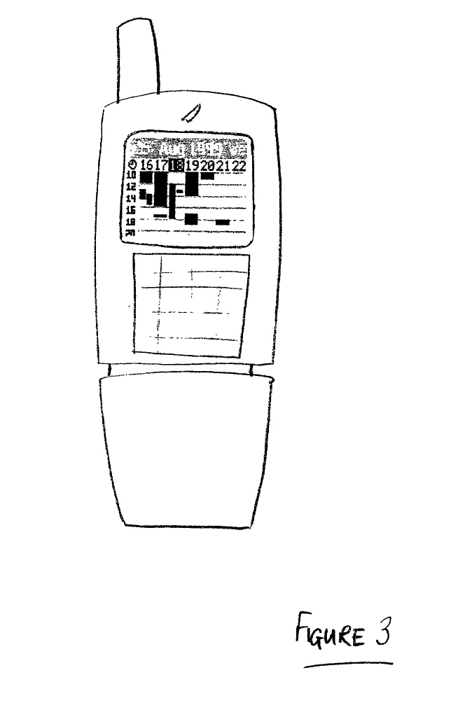

As described with reference to FIG. 1, known solutions for accessing event information represented by an indicator on a calendar display are limited and are not ideally suited to mobile telephones in particular. FIG. 2 illustrates a calendar display produced in accordance with the present invention. The display, as before, includes headings 10 and 11 indicating of days of the week and an indication of times of the day. The events and appointments are represented by indicators which show the extent of the event. For example, an appointment is shown as having been made for 9.00 am until 11.00 am on the Monday.

In accordance with the present invention, each of the event indicators shown on the calendar display is assigned a label 15 which is displayed with the indicator. In the example shown in FIG. 2, the displayed event indicators are assigned labels which number the indicators sequentially from left to right. The user of the device can now access the information about a given event by simply inputting a symbol which matches the label assigned to the indicator for that event. For example, if the user wishes to access information regarding the event on Thursday at 1.00 pm then the user need only input the symbol “3”, since this is the symbol assigned as a label for the event indicator. The input of the symbol can be via the keypad or via a voice command. It is preferred that the label assigned to an event indicator is a single symbol so that a single input can be used to access the event information.

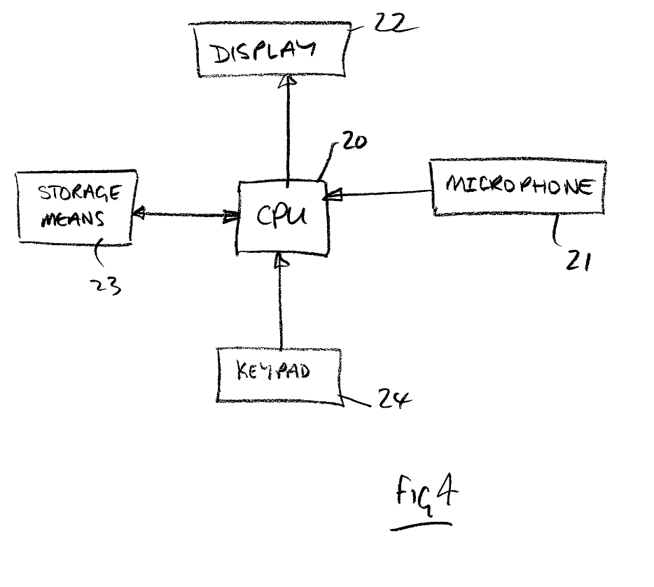

FIG. 3 illustrates, at substantially life size, a mobile telephone having a graphical display. The display is shown displaying a calendar representation. As will be readily appreciated from FIG. 3 the calendar image is likely to be larger than the display of the device. In that case, the user can scroll around the image, displaying a portion of the image at a time.

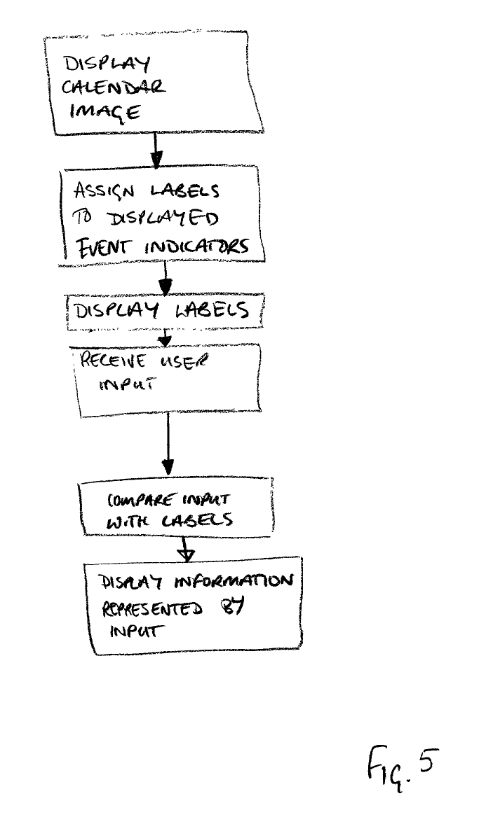

FIG. 4 is a block diagram illustrating functional blocks of a device operable in accordance with the present invention. A processing unit (CPU) 20 which receives inputs from a microphone 21 and a keypad 24. The CPU 20 outputs display information to the display 22, and can store data and retrieve data to and from storage means 23. A method embodying the present invention will now be described in more detail with reference to FIG. 3 and to the flow chart of FIG. 5.

At step A of FIG. 5, the calendar image is displayed on the display 22. It is to be noted that this calendar image can be all or only part of the total calendar to be displayed. At step B, labels are assigned to the displayed event indicators. The labels are assigned only for those event indicators that are displayed. Each time a new part of the calendar is displayed, labels are assigned.

The assigned labels are displayed with the indicators to which they have been assigned (step C). The CPU 20 awaits an input from the user (step D) and when this is received it is compared with the labels assigned to the event indicators (step E). When the input from the user matches a label displayed on the display, the information relating to the event indicated by the event indicator to which the label has been assigned is retrieved from the storage means 23 and displayed on the display 22.

It will be readily appreciated that the number of actions required by a user can therefore be reduced to a minimum which saves time and effort. The method embodying the present invention can be seen to accelerate the navigation of the graphical calendar, to the benefit of the user.

It will also be appreciated that a method embodying the present invention is not restricted for use on a mobile telephone, but can be useful in any electronic device where display space is at a premium. For example, the invention can usefully be applied to portable radio communication equipment, mobile radio terminals, pagers, communicators, electronic organizers, smartphones and personal digital assistants (PDAs). The assignment of single symbols to event indicators is also not to be construed as limiting, but merely a preferable embodiment.

1. A method of accessing information represented by an image on a graphical display of a portable electronic device, the method comprising:
displaying at least part of the image on a display of the device, the image including indicators representing respective items defined by a user of the device;
assigning respective labels to the indicators included in the image;
displaying the labels on the image with the respective indicators;
receiving an input symbol from a user of the device;
comparing the input symbol with the labels displayed on the image; and
if the input symbol matches a label displayed on the image, retrieving information relating to the item represented by the indicator to which the label is assigned, and displaying the retrieved event information on the display device of the portable electronic device.

2. A method as claimed in claim 1, wherein the image is a calendar image and the indicators relate to events.

3. A method as claimed in claim 1, wherein the symbol is input via a voice signal.

4. A method as claimed in claim 1, wherein the symbol is input by the user via a keypad of the device.

5. A method as claimed in claim 1, wherein the portable electronic device is a mobile telephone.

6. A method of accessing information represented by a graphical information indicator on a display, the method comprising displaying graphical information indicators on a display device, assigning respective labels to displayed indicators, displaying the labels, receiving a input symbol from a user, matching the input symbol with a displayed label, and displaying information represented by the information indicator to which the matched label is assigned.

7. A method as claimed in claim 6, wherein the graphical display is a calendar display.

8. A portable electronic device comprising a display device for displaying graphical images, and a control unit which is operable to cause at least part of an image to be displayed on the display device, the image including indicators representing respective items defined by a user of the device, wherein the control unit is operable to assign respective labels to the indicators included in the image, to cause the labels to be displayed on the display device with the respective indicators, to receive an input symbol from a user of the device, to compare the input symbol with the displayed labels, and, if the input symbol matches a displayed label, to retrieve information relating to the item represented by the indicator to which the label is assigned, and to display such retrieved information on the display device.

9. A device as claimed in claim 8, wherein the image is a calendar image and the indicators relate to events.

10. A device as claimed in claim 8, including means for receiving a voice input signal, and the input symbol is a voice signal.

11. A device as claimed in claim 8, including a keypad, the input symbol being input via the keypad.

12. A device as claimed in claim 8, being a mobile telephone.
